(19) United States
(12) Patent Application Publication
(10) Pub. No.: US 2017/0086475 A1
(43) Pub. Date: Mar. 30, 2017

(54) COMPOSITION IN THE FORM OF COMPACTED PARTICLES AND USE THEREOF

(71) Applicant: GELITA AG, Eberbach (DE)

(72) Inventors: Eberhard DICK, Neckargemünd (DE); Sonja GÖTTLING, Heppenheim (DE); Sigrid WIRTH, Neunkirchen (DE); Jens BEISEL, Rothenberg (DE)

(21) Appl. No.: 15/373,586

(22) Filed: Dec. 9, 2016

Related U.S. Application Data
(63) Continuation of application No. PCT/EP2015/063456, filed on Jun. 16, 2015.

(30) Foreign Application Priority Data
Jun. 17, 2014 (DE) 10 2014 108 502.7

(51) Int. Cl. A23G 3/44; A23L 33/28; A23L 29/281; A23J 3/06; A23L 9/10

(52) U.S. Cl. CPC A23G 3/44; A23J 3/06; A23L 9/10; A23L 29/284; A23L 33/28; A23V 2002/00

(57) ABSTRACT

The present invention relates to a composition in the form of compacted particles, comprising at least 5 wt %, preferably at least 10 wt %, more preferably at least 15 wt %, of gelatin and/or collagen hydrolysate.

### CROSS-REFERENCE TO RELATED APPLICATIONS

This patent application is a Continuation of International Patent Application No. PCT/EP2015/063456, filed Jun. 16, 2015, which claims the benefit of German Patent Application No. 10 2014 108 502.7, filed Jun. 17, 2014, which are each incorporated by reference.

### BACKGROUND OF THE INVENTION

The present invention relates to a composition in the form of compacted particles.

The invention also relates to the use of this composition, in particular for the production of foodstuffs.

Various types of foodstuffs, particularly confectionery products and desserts, obtain their typical consistency by means of a gelatin gel. In order to produce such a gel, a homogeneous solution of the gelatin in water or an aqueous medium must first be produced. Depending on the type of foodstuff, this gelatin solution can be available on a scale of industrial production (for example in the case of fruit gums) or on a scale of individual production of the product in a state ready for eating by the consumer (for example in the case of jellies).

The production of such gelatin solutions is often associated with technical problems, which can originate from the properties both of the gelatin used and also further components, which must be dissolved together with the gelatin for the production of the particular product. In particular, a combination of low density and poor wettability of the gelatin and/or further components, which are usually present in powder form, and also the required high concentration of the solution means that complete dissolution is not always possible, thus resulting in a high risk of the formation of lumps. These lumps can only be dissolved, if at all, by mechanical size reduction and long waiting times, which is uneconomical. An alternative would be to prevent clumping by vigorous agitation, which in turn leads to an undesirable formation of foam

On this basis, the object of the invention is to propose a composition with which an aqueous solution of gelatin and one or more further components, which solution in particular is suitable for further processing into foodstuffs, can be produced quickly and effectively.

### BRIEF SUMMARY OF THE INVENTION

This object is achieved by a composition of the type mentioned in the introduction in the form of compacted particles, comprising at least 5 wt % of gelatin and/or collagen hydrolysate.

The composition according to the invention is produced by a compaction, i.e. compression, of gelatin and/or collagen hydrolysate, and also further components as appropriate. Suitable methods for such a compaction, such as roller compaction, are known from the prior art. Interestingly, it has been found within the scope of the invention that the compaction, in spite of the smaller specific surface compared to powdered starting materials, leads to an overall quicker and technically less complex dissolution in water or an aqueous medium, since in particular specific procedures and method steps intended to prevent the formation of lumps and foam are no longer necessary and yet the formation of lumps and foam is still reduced or avoided entirely.

In the case of compaction methods, such as roller compaction, the starting material is compressed into compacted particles by application of a force from two opposite directions (i.e. for example by two parallel rollers). In contrast hereto, tableting methods in particular are known, in which case a starting material is pressed into a negative mould which is closed on a number of sides in order to produce tablets or similar pharmaceutical administration forms.

### DETAILED DESCRIPTION OF THE INVENTION

For certain applications, the composition according to the invention comprises only a relatively small proportion of at least 5 wt % of gelatin and/or collagen hydrolysate, preferably at least 10 wt %, more preferably at least 15 wt %.

Other applications require a higher content of gelatin and/or collagen hydrolysate of at least 40 wt %, preferably at least 60 wt %, more preferably at least 80 wt %.

The fact that all components or a majority of the components required for the particular end product can be dissolved together in a single method step with the aid of the composition according to the invention, without having to observe a specific order of addition, is also advantageous. It is thus possible to prevent the dissolution process of poorly soluble components from being slowed down even more or completely prevented by the dissolution of easily soluble components dissolved beforehand due to the fact that, on account of their dissolution, they significantly reduce the amount of freely available water. Many dissolving processes can thus be simplified and accelerated on the whole.

In some preferred embodiments of the invention the composition therefore comprises at least one further component which is water-soluble at room temperature, in addition to the gelatin and/or the collagen hydrolysate.

The compacted particles are produced in accordance with the invention in particular by compaction of a substantially dry solid material mixture. In contrast to compaction or compression of moist starting materials, particles having the desired properties, in particular a high bulk density, can be obtained in this way.

The substantially dry solid material mixture in particular does not contain any free water, but only bound water, in particular in the gelatin and/or the collagen hydrolysate. For example, dry gelatin under normal ambient conditions thus has a bound water proportion in the range of approximately 8 to 12 wt %.

When producing the composition according to the invention, compacted particles which are stable against segregation are preferably produced from fine-powdered pre-mixes with the aid of the compaction process, wherein the process conveniently includes a grinding and sieving operation in addition to the pure compaction. The grinding determines the maximum size of the particles, whereas the fine and coarse proportions can be removed via the downstream sieving process so as to then be fed back either to the compaction process or the mill.

Due to the appropriate adjustment of the mill and the combination of different sieves, the mean particle diameter and grain size distributions can be adjusted within a wide range. It is generally true that the narrower the grain size distribution, the more material must be fed back to the compaction or the mill, which is detrimental to the efficiency of the process. Depending on the degree to which the starting mixture can be compacted and depending on the desired grain size distribution, yields of from 30 to 80%, in particular from 40 to 60%, of compacted particles can be attained with one compaction cycle.

The selection of the grain size distribution is focused in particular on the later use of the compacted particles. In order to produce highly concentrated gelatin-containing solutions, as are typical for example for the production of gummy confectionery products or soft gelatin capsules, the particles should preferably have a mean particle diameter of from 0.8 to 4.2 mm, in particular from 1.3 to 2.8 mm. The grain size distribution can be relatively wide, wherein preferably at least 75% of the particles lie in the range of ±80%, in particular ±50% of the mean particle diameter. With particles in this size range, the described advantages can be achieved particularly well.

The bulk weight of the compacted particles lies preferably in a range of from 350 to 800 g/l, in particular from 400 to 700 g/l.

A preferred embodiment of the invention relates to a composition provided for the production of confectionery products on the basis of a gelatin gel, such as gummy bears or fruit gums. In order to produce the casting solution for products of this type, conventional gelatin is used as a starting point, which, on account of its primarily crystalline structure (amorphous proportion of less than 25%), is soluble in water only at increased temperatures (generally from approximately 60° C.).

In terms of production (appearance, drying, etc.), the casting solution for such products should have a minimal water content, in particular less than 40 wt %. The production of an accordingly highly concentrated solution of gelatin and further components of confectionery products then becomes problematic in particular when collagen hydrolysate is used in larger quantities as one of these components. Gelatin-based confectionery products which additionally contain collagen hydrolysate are offered as what is known as “functional food” on account of the health-promoting properties of collagen hydrolysate. In view of a nutritional optimisation of the end product, it is expedient to provide a high concentration of collagen hydrolysate, since a specific dosing per day is necessary in order to attain the sought health effect. Since gummy sweets, etc. consist predominantly of sugar, in the case of a low dosing of collagen hydrolysate the associated inclusion of sugar would inevitably no longer be acceptable from a nutritional viewpoint.

In order to meet these requirements, relatively high quantities of collagen hydrolysate must be dissolved in relatively little water when producing the casting solution, which is inevitably associated, in the case of a powdery starting product, with the formation of foam, formation of lumps and/or a very long waiting time. The process is therefore inefficient or leads to quality deficiencies of the product.

The joint compaction of gelatin and collagen hydrolysate (and further components as appropriate) therefore constitutes a particularly effective possibility within the scope of the invention for producing relatively highly concentrated solutions with low outlay. As already described above, the compacted particles, on account of their higher density, can firstly be wetted and can disperse well, and then can dissolve by means of gentle agitation.

The composition in this embodiment favourably comprises 20 to 80 wt % of collagen hydrolysate, in particular 35 to 70 wt %. Here, the proportion of gelatin can lie in particular in a range of from 10 to 80 wt %.

The collagen hydrolysate typically has a mean molecular weight of from 1,000 to 8,000 Da, in particular from 2,000 to 5,000 Da. Hydrolysates of this type are water-soluble at room temperature and, in contrast to gelatin, are not capable of gelling, i.e. the gelling ability is the fundamental distinguishing feature between gelatin and collagen hydrolysate. The gelling strength of the used gelatin lies preferably in a range of from 160 to 300 g Bloom, in particular from 180 to 280 g Bloom.

In conjunction with this embodiment, the invention also relates to the use of a composition of this type for the production of confectionery products on the basis of a gelatin gel, wherein the production comprises a step of dissolution of the compacted particles in water at 60 to 90° C., such that a solution having a solid material content of from 33 to 60 wt % results. This is added to the sugar charge in accordance with the recipe (dosing according to the desired active substance content), similarly to conventional gelatin solutions in the production of standard products.

A further preferred embodiment of the invention relates to compositions which are provided for the production of gelatin desserts (for example jellies) by the consumer, wherein the gelatin has an amorphous proportion of 98% or more. A gelatin of this type is also referred to as instant gelatin, since, in contrast to conventional gelatins, in which case dissolution in warm conditions is absolutely required, these gelatins can be processed in cold conditions, wherein these gelatins form what are known as pseudo-gels at room temperature. The preparation required by the end consumer in order to produce a dessert of this type is thus significantly simplified.

Although the solid material content of the gelatin solution to be produced is generally less than 30 wt % for such products, the dissolution of the instant gelatins in their conventional powder form is very problematic, since it either results in a formation of lumps or, with vigorous agitation, results in the formation of foam as a result of the introduction of air. The enclosed air cannot escape prior to the relatively quick gelling, which leads to a cloudy gel.

By use of the composition according to the invention in the form of compacted particles, this problem can be minimised in that the higher density of the particles leads to a quicker dispersion.

An additional advantageous effect can be obtained in accordance with a preferred embodiment of the invention in that the composition comprises at least one further water-soluble component. This component acts here as a “filling release agent”, which initially protects the gelatin against clumping. Whilst the further component is then dissolved steadily, the gelatin also can be initially hydrated and lastly dissolved, such that a homogeneous, clear solution is produced.

The at least one further component is particularly advantageously selected from one or more sugars, oligosaccharides (for example sucrose, glucose or maltodextrin) and/or sugar substitutes (for example sugar alcohols such as sorbitol). On the one hand, sugars or sugar substitutes are readily contained in the specified desserts, and on the other hand are particularly suitable for achieving the above-described effect on account of their good solubility.

The composition preferably comprises 50 to 95 wt %, in particular 65 to 75 wt %, of sugar, oligosaccharides and/or sugar substitutes.

In this regard, the invention also relates to the use of a composition of this type for the production of desserts on the basis of a gelatin gel, wherein the production comprises a step of dissolution of the compacted particles in water at 10 to 40° C., such that a solution having a solid material content of less than 30 wt % results.

In the case of a use for the production of foodstuffs, the composition according to the invention can comprise one or more further components selected from flavourings, colourings, acid regulators, emulsifiers, stabilisers, wetting agents, and preservatives. In principle, all desired constituents of the end product can be integrated in the compacted particles, such that a particularly simple process sequence results for the production.

A further preferred application of the composition according to the invention relates to products formed of powdery constituents with large density differences, in which case there is a high risk that the individual components will segregate again as a result of the handling during further processing, for example during packaging. With the aid of the compaction process, homogeneous agglomerates stable against segregation are produced from the fine-powdered premixes, the individual components of said agglomerates being fixedly incorporated in the agglomerate matrix in a constant ratio. The products thus produced can no longer separate mechanically on account of their density differences and demonstrate an increased bulk weight compared to the mixture of the various individual components.

### BRIEF DESCRIPTION OF THE DRAWING

These and further advantages of the invention will be explained in greater detail on the basis of the following practical examples with reference to the drawing, in which:

FIG. 1: shows a flow diagram for the production of gummy sweets from compacted particles according to the invention.

### EXAMPLES

### Example 1

Compacted particles containing gelatin and collagen hydrolysate for the production of “Beauty” gummy sweets.

A mixture was produced from 28.6 wt % of powdered gelatin (particle size <0.2 mm; bulk weight 582 g/1) and 71.4 wt % of a collagen hydrolysate (particle size <0.150 mm; bulk weight 304 g/1), which is obtainable from GELITA AG under the name Verisol®. In order to prevent sticking during the compaction, 0.01 wt % of magnesium stearate was additionally added. This mixture was subjected to a compaction process, wherein the proportion having a particle size between 1 and 4 mm was defined as desired end product (desired granular product).

The mixture was compacted at a rate of 80 kg/h and under a pressure of 40 kN, and was ground and sieved. The yield for one compaction cycle was 72%. There were no oversized grains, since the fine grain proportion of 28% was directly fed back continuously to the compaction process.

The desired granular product proportion had a mean grain size of 3 mm and a grain size distribution of from 0.8 to 3.8 mm.

The obtained particles (agglomerates of gelatin and collagen hydrolysate) were used for the production of gummy sweets having an active substance proportion (proportion of Verisol® collagen hydrolysate) of approximately 30 wt %. The production sequence for this is similar to the production of standard gummy sweets, but with a composition of the casting compound resulting from the modified recipe. This had, in this example, a water content of 35 wt % instead of the usual 25 wt %, whereby the process included a longer drying time in order to achieve the water content of less than 20 wt %, which is important for the end product.

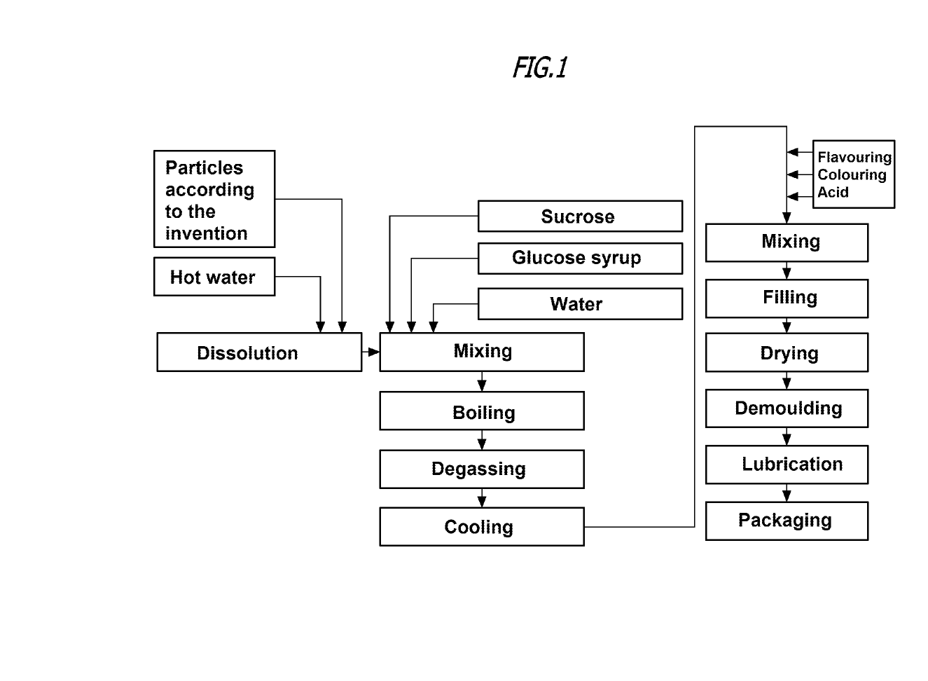

The process sequence was executed in accordance with the flow diagram illustrated in FIG. 1. The recipe used was formed of the components specified in Table 1.

TABLE 1

| Component | Proportion in wt % |
|---|---|
| Sucrose | 17.0 |
| Glucose syrup 42 DE (dextrose units) | 22.7 |
| Compacted particles according to the | 32.4 |
| invention | |
| Water | 24.6 |
| Citric acid 50% | 3.2 |
| Flavourings and Colourings | as required |
| Anti-stick agents | as required |
| Sum | 100.0 |

The end product had the properties typical for gummy sweets.

### Example 2

Compacted particles containing gelatin and collagen hydrolysate for the production of reduced-sugar gummy sweets.

A mixture was produced from 24 wt % of powdered gelatin (particle size <0.2 mm; bulk weight 612 g/l) and 76 wt % of a collagen hydrolysate (particle size <0.15 mm; bulk weight 320 g/l), which is obtainable from GELITA AG under the name Peptiplus®. In order to prevent sticking during the compaction, 0.01 wt % of magnesium stearate was additionally added. This mixture was subjected to a compaction process, wherein the proportion having a particle size between 1 and 4 mm was selected as the desired granular product.

The mixture was compacted at a rate of 73 kg/h and under a pressure of 45 kN, and was ground and sieved. The yield for one compaction cycle was 75%. There were no oversized grains, the fine grain proportion of 25% was directly fed back continuously to the compaction process.

The desired granular product proportion had a mean grain size of 3 mm and a grain size distribution of from 0.8 to 3.8 mm.

These particles were used for the production of gummy sweets having a sugar content reduced by 30%. The production was performed as described in Example 1, but with a modified recipe, which made it possible to set the water content of the casting solution to approximately 30 wt %, which required a shorter drying time compared to Example 1.

The recipe used was formed of the components specified in Table 2.

TABLE 2

| Component | Proportion in wt % |
|---|---|
| Sucrose | 19.5 |
| Glucose syrup 42 DE | 25.9 |
| Compacted particles according to the | 24.8 |
| invention | |
| Water | 28.1 |
| Citric acid 50% | 1.7 |
| Sum | 100.0 |

The end product had the properties typical for gummy sweets.

### Example 3

“Complete compound” based on instant gelatin for the production of jelly

A mixture was produced from 10 wt % of instant gelatin (particle size <0.17 mm; bulk weight 347 g/l), 88.3 wt % of castor sugar (fine-grain sucrose), 1.7 wt % of citric acid powder, and appropriate amounts of flavourings and colourings. This mixture was subjected to a compaction process, wherein the proportion having a grain size between 0.1 and 0.5 mm was selected as the desired granular product.

The mixture was compacted at a rate of 81 kg/h and under a pressure of 80 kN, and was ground and sieved. The resultant desired granular product proportion had a bulk weight of 684 g/l.

By stirring 120 g of these particles according to the invention into 500 ml of cold water, the ready-to-eat jelly product was obtained after a defined cooling time.

### Example 4

Dietary supplement based on a collagen hydrolysate, calcium lactate, and vitamin D

A mixture was produced from 37 wt % of a collagen hydrolysate (particle size <0.16 mm; bulk weight 374 g/l), which is obtainable from GELITA AG under the name Fortibone®, 27 wt % of calcium lactate, and 0.03 wt % of vitamin D. The bulk weight of the mixture was 467 g/l. This mixture was subjected to a compaction process, wherein two proportions having a grain size, respectively, between 0.1 and 0.25 mm and between 0.8 and 1.0 mm were selected as the desired granular product.

The mixture was compacted at a pressure of 50 kN, and was ground and sieved.

Hard capsules were filled with the particles thus produced. The filling of the hard capsules was significantly easier than when filling the capsules with the fine-powdered starting materials on account of the good pourability of the product, and there was no risk of segregation of the filling material during the filling process.

Due to the higher bulk weight, it was possible to achieve a filling degree higher by 55% and 95%, respectively, compared to the non-compacted powder mixture, wherein the mixing of the two different desired granular product proportions proved to be particularly advantageous. The corresponding values can be found in Table 3.

The recommended daily dose of capsules can thus be significantly reduced.

TABLE 3

| | Powder | Compacted | |
|---|---|---|---|
| | mixture | particles | Compacted particles |
| Particle size | <0.16 mm | Proportion | Proportion 0.8-1.0 mm and |
| | | 0.8 to 1.0 mm | proportion 0.1-0.25 mm at |
| | | | a ratio of 2:1 |
| Filling | 0.22 g | 0.34 g | 0.43 g |
| quantity | | | |
| Filling degree | 100% | 155% | 195% |

1. A composition comprising at least 5 wt % of gelatin and/or collagen hydrolysate in the form of compacted particles.

2. The composition according to claim 1, comprising at least 40 wt % of gelatin and/or collagen hydrolysate.

3. The composition according to claim 1, further comprising at least one component, which is water-soluble at room temperature.

4. The composition according to claim 1, wherein the compacted particles are produced by compaction of a substantially dry solid material mixture.

5. The composition according to claim 4, wherein the solid material mixture contains bound water and does not contain any free water.

6. The composition according to claim 1, wherein the compacted particles have a mean particle diameter of from 0.8 to 4.2 mm.

7. The composition according to claim 1, wherein the compacted particles have a bulk weight of from 350 to 800 g/l.

8. The composition according to claim 1, wherein the composition comprises gelatin which has an amorphous proportion of less than 25%.

9. The composition according to claim 8, wherein the composition comprises 20 to 80 wt % of collagen.

10. The composition according to claim 8, wherein the composition comprises 10 to 80 wt % of gelatin.

11. The composition according to claim 9, wherein the collagen hydrolysate has a mean molecular weight of from 1,000 to 8,000 Da.

12. A method for the production of confectionery products, wherein the method comprises dissolving the composition of claim 8 in water at 60 to 90° C., such that a solution having a solid material content of from 33 to 60 wt % results.

13. The composition according to claim 1, wherein the composition comprises gelatin which has an amorphous proportion of 98% or more.

14. The composition according to claim 13, further comprising at least one component selected from one or more sugars, oligosaccharides and/or sugar substitutes.

15. The composition according to claim 14, comprising 50 to 95 wt % of sugar, oligosaccharides and/or sugar substitutes.

16. A method for the production of desserts wherein the method comprises dissolving the composition of claim 13 in water at 10 to 40° C., such that a solution having a solid material content of less than 30 wt % results.

17. The composition according to claim 1, further comprising one or more components selected from flavourings, colourings, acid regulators, emulsifiers, stabilisers, wetting agents, and preservatives.

18. The composition according to claim 2, comprising at least 80 wt % of gelatin and/or collagen hydrolysate.

19. The composition according to claim 6, wherein the compacted particles have a mean particle diameter of from 1.3 to 2.8 mm.

20. The composition according to claim 7, wherein the compacted particles have a bulk weight of from 400 to 700 g/l.
